(19) United States
(12) Patent Application Publication
(10) Pub. No.: US 2022/0009339 A1
(43) Pub. Date: Jan. 13, 2022

(54) HYBRIDIZED DOUBLE CLUTCH TRANSMISSION ARRANGEMENT

(71) Applicant: TREMEC, Zedelgem (BE)

(72) Inventors: Nico DE VISSCHER, Laarne (BE); Pieter MESEURE, Jabbeke (BE); Didier GENOUW, Eernegem (BE)

(21) Appl. No.: 17/293,859

(22) PCT Filed: Nov. 13, 2019
(86) PCT No.: PCT/EP2019/081136

§ 371 Date: May 13, 2021

(30) Foreign Application Priority Data
Nov. 13, 2018 (EP) 18206053.3

(51) Int. Cl. B60K 6/48; B60K 6/387; B60K 6/547; F16H 3/00; B60W 10/113; B60W 30/18; B60W 20/30; B60W 10/06; B60W 10/08; F16H 61/688

(52) U.S. Cl. CPC B60K 6/48; F16H 2003/008; B60K 6/547; F16H 3/006; B60W 10/113; B60W 30/18018; B60W 30/18027; B60W 20/30; B60W 10/06; B60W 10/08; F16H 61/688; B60K 2006/4825; B60K 2006/4816; B60K 2006/4808; B60K 6/387

(57) ABSTRACT

Provided is a dual clutch transmission for an internal combustion engine including a motor generator unit, MGU (M), for providing electric or hybrid driving capability wherein the MGU (M) is selectively connectable to a (one) transmission input shaft, or transmission output shaft or to neither shaft.

### FIELD OF THE INVENTION

The invention concerns the arrangement of hybridization of a double clutch transmission.

### BACKGROUND TO THE INVENTION

Double clutch transmissions are known in the field of combustion engines. They use two sets of gears and two clutches which are controlled such that an uninterrupted torque transmission is possible. A motor generator unit (MGU) may be added to a conventional powertrain to create a hybrid powertrain allowing higher fuel economy combined with increased performance. There is a need in the art for a double clutch transmission with an MGU that has advantages of efficiently boosting torque to the transmission output, yet can still be used to crank the combustion engine as well as charge the battery while standing still.

US 2011/0198139 discloses a dual clutch transmission incorporating a motor generator unit. Transfer of torque to loose gear wheels on the transmission input or output shafts requires a complex arrangement of bearings to bear forces caused by helical gear teeth. There is an increase in costs and weight of the transmission.

US 2014/0157923 discloses a dual clutch transmission incorporating a motor generator unit. The MGU cannot be directly connected to the countershaft because that connection goes over a loose gear wheel (D5 on the countershaft). In order to transfer torque, D5 must be selected. The disclosure does not allow the freedom to connect the MGU to the output/counter/main shaft independent of the ratio selection for the combustion engine.

US 2016/0325616 discloses a dual clutch transmission incorporating a motor generator unit. There is no disclosure of being able to select two different torque paths. There is no disclosure of a transfer of torque to loose gear wheels on the transmission input. When choosing a favourable ratio set, high acceleration cannot be combined with ability to drive at motor speeds in pure EV mode

### SUMMARY OF THE INVENTION

Provided herein is a dual clutch transmission (10) for a vehicle, comprising:
two sets of selectable speed gear pairs,
one or more transmission output shafts (26, 26a, 26a′, 26b), at least one transmission output shaft being a countershaft (26a, 26a′),
an outer transmission input shaft (3) shaft and an inner transmission input shaft (4) connected to the internal combustion engine, ICE, (12) via a dual clutch (20, 28, 30)
two sets of speed gears (22, 24) each set comprising a plurality of speed gear pairs (31-270; 33-272; 33′-272′; 42-264; 44-262),
   wherein
      in one set of speed gears (24), one gear (31, 33, 33′) of each speed gear pair is attached to the outer transmission input shaft (3), and
      in the other set (24) of speed gears (22), one gear (42, 44) of each speed gear pair is attached to the inner transmission input shaft (4),
      the other gear (270, 272, 272′, 262, 264) of each speed gear pair being attached to the at least one countershaft (26a, 26a′), wherein torque is transferred between the outer or inner transmission input shaft (3, 4) and the at least one countershaft (26a, 26a′) via a selected speed gear pair,
a motor generator unit, MGU (M), connected via 0, 1 or more gear steps (51, 51′ 58), to an MGU torque transfer shaft (55), wherein:
   the torque transfer shaft (55) on which two loose gear wheels (54, 56) are rotationally mounted, wherein none or either one of the two loose gear wheels (54, 56) can be brought into fixed rotation with the torque transfer shaft (55) by a selector (57);
   one of the loose gear wheels (54) on the torque transfer shaft (55) is meshed via 0, 1 or more gear steps with a fixed gear wheel (272′, 266, 268) on one of the transmission output shafts (26, 26a, 26a′, 26b), and
   the other loose gear wheel on the torque transfer shaft (55) is meshed via 0, 1 or more gear steps with a fixed gear (31, 33, 42, 44) on one of the transmission input shafts (3, 4)
   the fixed gear wheel (31, 33, 33′, 42, 44) on one of the transmission input shaft (3, 4) and/or the fixed gear wheel (272′) on one of the transmission output shafts (26, 26a, 26a′, 26b) that meshes via the 0, 1 or more gear steps with the loose gear wheel (54) on the torque transfer shaft (55) is a gear of a speed gear pair.

The dual clutch transmission (10) may be configured for selectively operating in a pure electric driving mode in which the selector (57) selects a torque path in which torque is transferred from the motor generator unit, MGU (M) via one of the transmission output shafts (26, 26a, 26a′, 26b).

The dual clutch transmission (10) may be configured for selectively operating in a sports performance pure electric driving mode in which the selector (57) selects a torque path where torque is transferred from the motor generator unit, MGU (M) via one of the transmission input shafts (3, 4), and gears shifts use the set (22, 24) of speed gears pairs attached to the same one transmission input shaft (3, 4).

The dual clutch transmission (10) may be configured for selectively operating in a battery charge mode while driving on the ICE (12), wherein the selector (57) selects the torque path where torque is transferred via one of the transmission input shaft (3, 4), and the ICE (12) delivers an additional amount of torque that is converted by the MGU into power to charge the battery.

The dual clutch transmission (10) may be configured for selectively operating in a hybrid mode that is a shift feeling enhancement mode wherein torque supplied by the MGU (M) causes an enhanced shift interrupt feel of a speed gear change by reducing or supplying negative torque during a shift, thereby enhancing a drop in acceleration during a speed gear change.

The dual clutch transmission (10) may be configured for selectively operating in a hybrid mode that is a shift feeling enhancement mode wherein the torque supplied by the MGU causes an enhanced shift boost feel of a gear change by increasing torque during and after clutch closing, thereby enhancing an increase in acceleration after a new speed gear change.

The dual clutch transmission (10) may be configured for selectively operating in a smooth stop-start mode applied from standstill or during driving at a speed, wherein:
when launching from standstill the selector (57) selects the torque path where torque is transferred via one of the transmission input shafts (3, 4) from the MGU (M) to the ICE (12) to be able to crank the ICE (12) while the corresponding clutch (28, 30) is closed with no speed gear selected; and
the clutch (28, 30) of the other transmission input shaft (3, 4), is used to smoothly transfer torque from the ICE (12) to the main output shaft (26b) via the speed gears pairs attached to the other transmission input shaft (4) and
when driving at speed and a release of accelerator pedal causes the ICE (12) to shut down, the ICE (12) is recranked by selecting with the selector (57) the torque path where torque is transferred via one of the transmission input shafts (3, 4) from the MGU (M) to the ICE (12) to be able to crank the ICE (12) while the corresponding clutch (20-28, 30) is closed with no speed gear selected; and
   the clutch (28, 30) of the other transmission input shaft (3, 4), is used to smoothly transfer torque from the ICE (12) to the main output shaft (26b) via the speed gears pairs attached the other transmission input shaft (4).

The dual clutch transmission (10) may be configured for driving in a hybrid mode wherein shift feeling is suppressed, wherein the the selector (57) selects the torque path where torque is transferred via a transmission input shaft (3,4), or the selector select the torque path where torque is transferred via a transmission output shaft (26, 26a, 26a′, 26b), and the MGU is applied to compensate at times where vehicle acceleration is briefly reduced due to the nature of DCT shifts in combination ICE capabilities.

The dual clutch transmission (10) may further comprise a control unit configured to determine based on one or more inputs including one or more of vehicle speed, hybrid mode, battery state of charge, driving direction, the position of the selector (57) and a control of the MGU (M) torque output.

The fixed gear of the speed gear pair on one of the transmission input shafts (3, 4) and/or on one of the transmission output shafts (26, 26a, 26a′, 26b) to which the loose gear loose gear wheels (54) on the torque transfer shaft (55) is meshed with may be an odd numbered speed gear. The odd numbered speed gear may be a 3^{rd} speed gear.

The fixed gear of the speed gear pair to which the loose gear loose gear wheels (54) on the torque transfer shaft (55) is meshed via 0, 1 or more gear steps may be only on the transmission input shafts (3, 4).

The dual clutch transmission (10) may be a transaxle.

The dual clutch transmission (10) may comprise a differential positioned behind or in front of the speed gears (22, 24) in a direction of travel, optionally in a transaxle.

The dual clutch transmission (10) may be configured for coupling with a combustion engine mounted in a longitudinal or transverse direction of a vehicle, optionally inline with the combustion engine (12).

Provided herein is a dual clutch transmission (10) for a vehicle, comprising a motor generator unit, MGU (M), for providing electric or hybrid driving capability wherein the MGU (M) is repeatably disconnectable by actuation from the transmission.

The MGU (M) may be repeatably connectable by actuation to one of the clutch output shafts (3,4).

The MGU (M) may be repeatably connectable by actuation to a transmission output (26).

The MGU (M) may be:
selectively repeatably connectable by actuation to one of the clutch output shafts (3,4) or the transmission output (26), and
selectively repeatably disconnectable by actuation from the one of the clutch output shafts (3,4) or the transmission output (26).

The dual clutch transmission (10) may be configured for standstill charging and cranking by the MGU (M) connected to the one of the clutch output shafts (3,4) and for a transmission output boosting by the MGU (M) connected to the transmission output (26).

The dual clutch transmission (10) may be configured for selection of different transmission gears (22, 24) when the MGU (M) is connected to the one of the clutch output shafts (3,4) during an electric or hybrid drive.

The dual clutch transmission (10) may be configured to be optimized for both low speed high performance pure electric drive and high speed maximal boosting.

The MGU (M) may be connected using one or more additional gear steps between gear 58 and MGU (M).

The dual clutch transmission (10) may be configured to allow pure electric propulsion without the need for permanent actuation power.

The dual clutch transmission (10) may further comprise a control unit that determines based on one or more inputs including one or more of vehicle speed, hybrid mode, battery state of charge, driving direction, if and how to connect and control the MGU (M).

The dual clutch transmission (10) may be a transaxle.

The dual clutch transmission (10) may comprise a differential positioned behind or in front of the transmission gears (22, 24) in a direction of travel, optionally in a transaxle.

The dual clutch transmission (10) may be configured for coupling with a combustion engine mounted in a longitudinal or transverse direction of a vehicle, optionally inline with the combustion engine (12).

The dual clutch transmission (10) may be configured with a modular design enabling addition of the MGU (M) with electric reverse or a mechanical reverse for non-hybrid vehicles without changes to hydraulic gear actuation and/or the transmission gears (22, 24).

Further provided herein is a vehicle comprising the dual clutch transmission (10) as described herein.

### FIGURE LEGENDS

FIG. 1 shows a double clutch transmission of the art.

FIG. 2 shows a conventional so-called P2 layout where an MGU is inserted between the combustion engine and the transmission with an additional clutch to disconnect the combustion engine and allow for pure electric drive.

FIG. 3 shows a conventional so-called P3 layout where an MGU is connected to the transmission output.

FIG. 4 shows the layout schematic of a double clutch transmission presently described which allows selective connection of the MGU to the transmission input shaft or the transmission output, or disconnection.

FIG. 5 shows an example of a layout of a double clutch transmission presently described which allows selective connection of the MGU to the transmission input shaft or the transmission output, or disconnection.

FIG. 6 shows the conversion of the transmission from selectable MGU connection to a conventional gearbox with mechanical reverse.

FIG. 7 shows a further example of a layout of a double clutch transmission (8 speed gears) presently described, where torque is selectively transferable between the MGU and one of transmission input shaft (4) and countershaft (26a). There is also a neutral position.

FIG. 8 shows a further example of a layout of a double clutch transmission (8 speed gears) presently described, where torque is selectively transferable between transmission input shaft (4) and countershaft (26a′). There is also a neutral position.

FIG. 9 shows a further example of a layout of a double clutch transmission (7 speed gears) presently described, where torque is selectively transferable between transmission input shaft (3) and countershaft (26a). There is also a neutral position.

FIG. 10 is a graph showing relationship between vehicle speed and rotation speed of the internal combustion engine (ICE) and MGU configured according to FIG. 8.

FIG. 11 is a graph showing relationship between tractive effort (wheel torque) and vehicle speed of the MGU at different speed gears configured according to FIG. 8.

### DETAILED DESCRIPTION OF INVENTION

Before the present system and method of the invention are described, it is to be understood that this invention is not limited to particular systems and methods or combinations described, since such systems and methods and combinations may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all numbers and fractions subsumed within the respective ranges, as well as the recited endpoints.

The term “about” or “approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” or “approximately” refers is itself also specifically, and preferably, disclosed.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any or etc. of said members, and up to all said members.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

In the present description of the invention, reference is made to the accompanying drawings that form a part hereof, and in which are shown by way of illustration only of specific embodiments in which the invention may be practiced. Parenthesized or emboldened reference numerals affixed to respective elements merely exemplify the elements by way of example, with which it is not intended to limit the respective elements. It is to be understood that other embodiments may be utilised and structural or logical changes may be made without departing from the scope of the present invention. The following detailed description, therefore, is not to be taken in a limiting sense, and the scope of the present invention is defined by the appended claims.

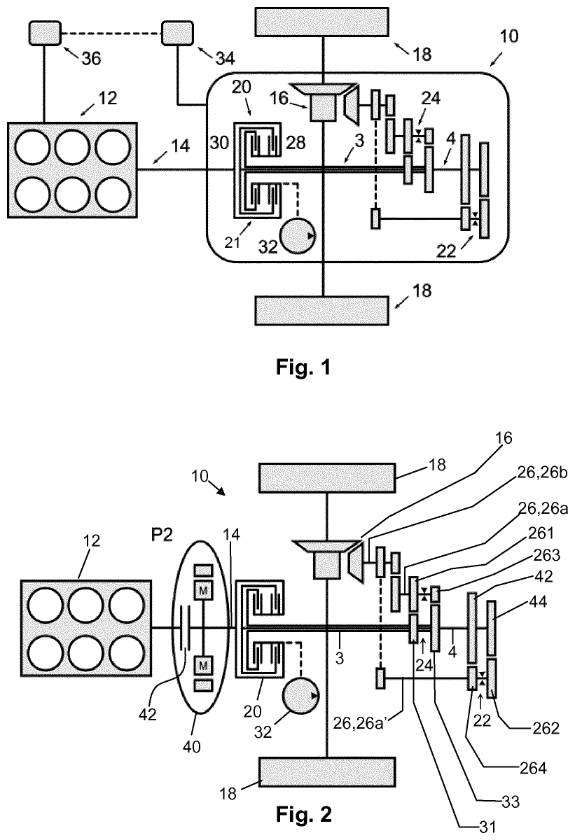

FIG. 1 shows a schematic example of a dual clutch transmission (10) for a vehicle known in the art. The dual clutch transmission (10) is adapted for transmitting a torque from an engine (12) (also known as an internal combustion engine (ICE)) through input shaft (14) to a differential (16) connected to two wheels (18) of a vehicle. The dual clutch transmission (10) comprises a dual clutch (20) and two sets of speed gears (22), (24). The details of sets of speed gears are known in the art and hence are neither fully drawn nor explained in great detail herein. These speed gears may be referred to as transmission gears or sets of gears or gear sets herein.

Each of the sets of speed gears (22, 24) has a transmission input- and a transmission output shaft and several pairs of gear wheels that provide different transmission ratios, i.e. gears, between the input shaft and the output shaft of the respective set of gears.

In general, the pairs of gear wheels for the odd gears (1st, 3rd, 5th and 7th gear) are arranged in the one set of gears (22), known as the first set of gears (22) herein. The pairs of gear wheels for the even gears (2nd, 4^{th}, 6th gear and 8^{th}) and the reverse gear (R) are arranged in the other set of gears (24), the second set of gears (24) herein.

Each set of speed gears (22, 24) comprises a plurality of speed gear pairs (also known as gear stage gear pairs). One gear of a speed gear pair is attached to clutch output shaft (3 or 4). A clutch output shaft (3 or 4) is also known as a transmission input shaft (3 or 4). The corresponding gear of the speed gear pair is attached to an output shaft (26) that is a countershaft (also known as main shaft) (26a or 26a′). There may be one or two countershafts. The counter-shaft (26a or 26a′) may drive a further output shaft (26) that is a main output shaft (26b). The output shaft (26) (e.g. main output shaft (26b)) drives a differential (16).

The dual clutch (20) comprises a cage or housing (21) drivingly connected to a crank shaft of the ICE (12), a set of first clutch plates (28) and a set of second clutch plates (30). For easy reference, the sets of clutch plates (28, 30) are referred to herein as “clutch”.

The first clutch (28), if engaged, provides for torque transmission from ICE (12) to the first set of gears (22) via a first transmission input shaft (4). Likewise, the second clutch (30), if engaged, provides for torque transmission from ICE (12) to the second set of gears (24) via a second transmission input shaft (3).

The skilled person will understand that the labelling of the set of gears (22, 24) and clutches (28, 30) is arbitrary and can be changed without departing from the inventive idea.

The transmission output shafts (26, 26a, 26a′, 26b) of the set of gears (22, 24) are drivingly connected to the differential (16). The clutches (28, 30) can be engaged and released independently by a transmission control unit (34), and transmission control unit (34) may be capable of selecting the active gear, i.e. the pair of gear wheels that engage and transmit torque, of the sets of gears (22, 24). The actuation of the clutches (28, 30) and selection of the gear sets (22, 24) can be achieved by hydraulic power provided by a pump (32) that may be connected to the input shaft (14).

The differential (16) may be integrated to the dual clutch transmission (10), and the combined component is commonly known as a transaxle. The differential (16) may be positioned in front of or behind the gear sets (22, 24) with respect to the forward direction of travel.

The transmission control unit (34) maybe connected to an engine control unit (36) or appropriate sensors (not shown).

It is possible that the transmission control unit (34) itself is part of the engine control unit (36).

An electric machine, often called MGU (motor generator unit) (M) may be added to a conventional powertrain to create a hybrid powertrain allowing higher fuel economy combined with increased performance. The MGU (M) may outputs torque to ultimately drive the differential and/or receive torque to recharge the battery. Known features of adding an MGU to a conventional gearbox can be starting the combustion engine, charging the hybrid vehicle battery while driving (regenerative braking or load point shift), charging the battery while standing still, full electric drive and assisting the combustion engine during heavy acceleration (often referred to as boosting).

The field of hybridized transmission knows several layouts of hybridization or electrification of conventional gearboxes. An MGU (M) can be placed between the ICE (12) and the transmission input (14) and is connected to a disconnect clutch (42) between the ICE (12) and the MGU (M) allowing full electric drive with disconnected ICE (12). This is shown FIG. 2 and is often referred to as a P2 layout. The combination of the MGU (M) and disconnect clutch (42) is shown as an MGU assembly (40). A P2 layout may be used to start the combustion engine, charge the battery at standstill and allows use of all the conventional gears for pure electric drive. The main disadvantages of this layout are related to the fact that all torque passes through the whole transmission. This means that during pure electric drive most of the gearbox is spinning and creating losses. Since gearbox efficiency levels are known to be low at low levels of input torque or power this can have a negative impact on battery capacity or electric range. Another result of having all the electric power available at the input of the transmission is that during heavy accelerations where both the combustion engine and the MGU are working together very high torque levels are achieved at transmission input. This leads to the need of stronger and heavier gears and shafts or alternatively limits on how much torque both systems can deliver together. With this layout the conventional combustion engine driven hydraulic pump (32) is also driven by the MGU and creating additional power losses.

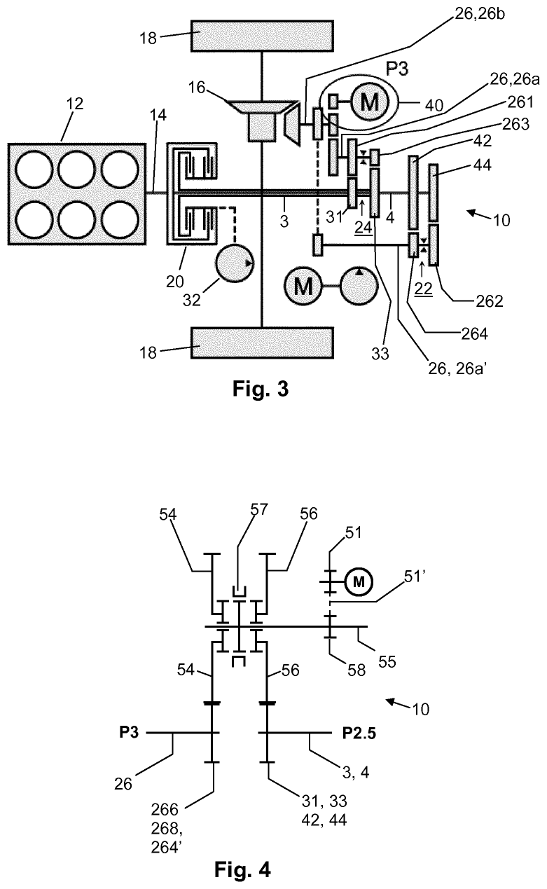

In another layout the MGU (M) is placed on the output of the transmission (26) as shown in FIG. 3, often referred to as P3 layout. In particular, it is attached to the main output shaft (26b). In this layout the torque from the MGU (M) is added to the final stage of the transmission resulting in fewer components that encounter a high combined torque load and fewer transmission components that spin and create losses during pure electric drive. In this layout there is also no need to actuate one of the clutches during pure electric drive, also the conventional engine driven hydraulic pump (32) is not spinning. A disadvantage of this layout is that having the MGU connected to the transmission output does not enable cranking of the combustion engine or charging of the battery at standstill.

Apart from the additional possibilities of hybridization it is also critical to look at added weight, combined torque levels for different components, cost, efficiency and controllability. Depending on the goal of the car some features or attributes may be of higher importance. The present invention provides an optimum balance of feature availability with weight, efficiency, cost and modularity for high performance sports cars.

In the present invention, the MGU (M) may be selectively connected or connectable to the transmission output (26) or selectively connected to a (one) transmission input shaft (3 or 4) or may also be disconnected or disconnectable.

In particular, and referring to FIG. 4 as an example, the double clutch transmission (10) comprises a MGU (M) that is connected (i.e. drives or is driven by), via 0, 1 or more gear steps (51, 51′ 58), to an MGU torque transfer shaft (55). Torque transfer shaft (55) transmits torque (shaft as output) or can receive torque for electricity generation (shaft as input). Torque transfer shaft (55) is provided with two loose gear wheels (54, 56), wherein none or either one of the two loose gear wheels (54, 56) can be brought into fixed rotation with the torque transfer shaft (55) by a selector (57).

One of the loose gear wheels (54) on the torque transfer shaft (55) is meshed via 0, 1 or more (preferably 0) gear steps with a gear wheel (266, 268, 272′) on a transmission output shaft (26) (e.g. the counter shaft (26a, 26a′) or the main output shaft (26b)); the gear wheel (266, 268) on the transmission output shaft (26) is (permanently, non-selectively) rotationally fixed to the transmission output shaft (26).

The other loose gear wheel on the torque transfer shaft (55) is meshed via 0, 1 or more (preferably 0) gear steps with a gear wheel (31, 33, 42, 44) on one of the transmission input shafts (3, 4); the gear wheel (31, 33, 42, 44) on the transmission input shaft (3, 4) is (permanently, non-selectively) rotationally fixed to the transmission input shaft (3, 4).

The fixed gear wheel (272′) on the output shaft (26) and/or the fixed gear wheel (31, 33, 42, 44) on the transmission input shaft (3, 4) is a gear of a speed gear pair. The speed gear may be a 3^{rd} or 4^{th} gear. The fixed gear wheel (31, 33, 42, 44) on the transmission input shaft (3, 4) may be the gear of a speed gear pair.

Any of the transmission output shafts (26, 26a, 26a′, 26b) may be directly connected with the differential (16) to drive the wheels of the vehicle. In some configurations, the countershaft (26a, 26a′) outputs torque to the differential (16) and there is no further shaft (e.g. no separate main output shaft (26b). In some configurations, a main output shaft (26b) outputs torque to the differential (16) which is operatively connected to one of the countershafts (26a, 26a′).

The selector (57) hence, has a neutral position where the torque transfer shaft (55) is neither transmitting nor receiving torque. It has a position (left) where there one of the two loose gear wheels (54) is brought into fixed rotation with the torque transfer shaft (55), and torque is transferred between the torque transfer shaft (55) and one of the transmission output shafts (26) (e.g. the counter shaft (26a, 26a′) or the main output shaft (26b)). It has a position (right) where the other of the two loose gear wheels (56) is brought into fixed rotation with the torque transfer shaft (55), and torque is transferred between the torque transfer shaft (55) and one of the transmission input shafts (3,4).

The speed gear wheels and the loose gear wheels (54) may be of a helical type i.e. gear teeth inclined with respect to an axial direction of the outer surface of the wheel.

An MGU assembly (50) may comprise MGU (M), optional gear steps (51, 51′, 58), two loose gear wheels (54, 56) and selector (57).

A selector (57) refers to any assembly that reproducibly brings a loose gear wheel normally revolutely attached to a shaft, into locked rotation with the shaft. The selector may comprise a synchroniser or dog clutch or other connection device such as a with or without a mechanical synchronization. A synchroniser typically comprises a hub permanently rotationally fixed and permanently axially fixed to the shaft. The synchroniser typically further comprises a sleeve, rotationally fixed to the hub that is slidable relative to the hub. The movement of the sleeve towards the free-spinning gear engages the sleeve with locking toothing on the free-spinning gear, so that the rotation of the shaft and free-spinning gear become locked or synchronised. The locking toothing on the gear is separate from the gear teeth that mesh with the other gear of the gear pair. A synchroniser may contain other elements such as a friction cone on the selected gear, synchroniser ring having a conical surface that engages with the friction cone on the selected gear. Other variations of a synchroniser exist as is understood in the art.

The double clutch transmission (10) may have 4 or more speed (forward) gears, and a reverse gear. Preferably, there are between 6-8 speed gears and hence speed gear pairs. The speed gear pairs may give an ICE/wheel ratio of 14.87:1 (1^{st} gear) to 1.81:1 (top gear). There may preferably be 8 speed gears, having exemplary ratios according to Table 1 below.

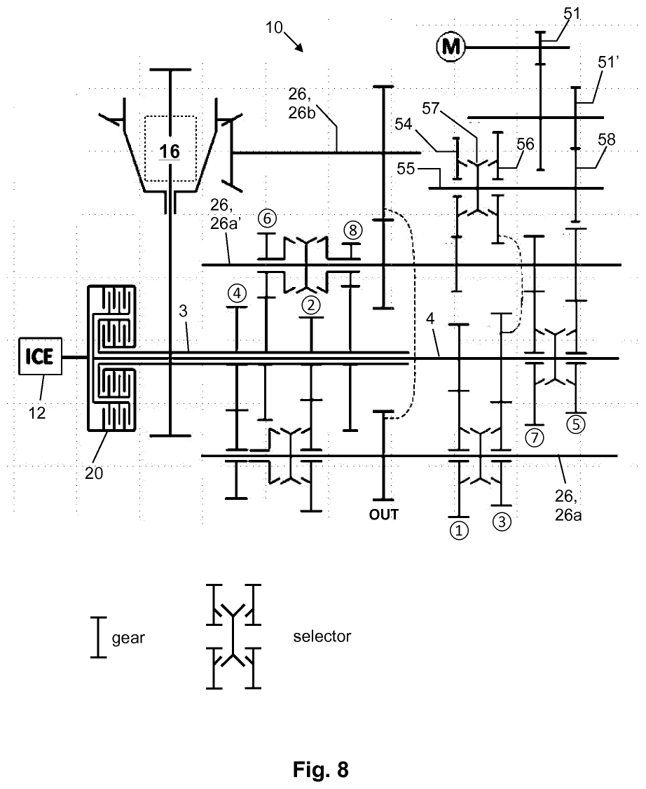

TABLE 1
ICE gear ratio to wheel for selected gear speed. The
ratios correspond to the configuration of FIG. 8.

| Speed gear | ICE gear ratio to |
|---|---|
| selected | wheels (example) |
| 1 | 14.78 |
| 2 | 10.66 |
| 3 | 8.14 |
| 4 | 6.05 |
| 5 | 4.83 |
| 6 | 3.72 |
| 7 | 3.05 |
| 8 | 1.81 |

When the selector (57) is set such that torque is transmitted between the torque transfer shaft (55) and a transmission output shaft (26) the MGU gear/wheel ratio may span 8-10:1. When the selector (57) is set such that torque is transmitted between the torque transfer shaft (55) and a transmission input shafts (3, 4), the MGU gear/wheel ratio may span 25-30:1 (1^{st} gear) to 3-5:1 (top gear) depending on the gear selected. Exemplary ratios are indicated in Table 2 below:

TABLE 2
ICE gear ratio to wheel for selected gear speed. The
ratios correspond to the configuration of FIG. 8.

| MGU gear | MGU gear ratio to |
|---|---|
| selected | wheels (example) |
| P3-mode | 10.32 |
| P2.5-mode - 1 | 26.60 |
| P2.5-mode - 3 | 14.65 |
| P2.5-mode - 5 | 8.69 |
| P2.5-mode - 7 | 5.49 |

The gear pair ratios may be chosen such that typical motorway driving speed is supported in pure electric driving mode in 3^{rd} gear i.e. when the selector (57) has a position (right in FIG. 4) where the other of the two loose gear wheels (56) is brought into fixed rotation with the torque transfer shaft (55), and torque is transferred between the torque transfer shaft (55) and one of the transmission input shafts (3,4).

By using a fixed gear (31, 33, 42, 44) of the speed gear pair on the transmission input shaft (3, 4) or a fixed gear of the speed gear pair on the transmission output shaft (26) for a transfer of torque to/from the MGU, space, weight, cost is saved because an additional gear wheel on the transmission input shaft is not needed.

By using a fixed speed gear (31, 33, 42, 44) instead of a loose gear wheel on the transmission input shaft (3, 4) and/or transmission output shaft (26) for a transfer of torque to/from the MGU (M), a complex bearing arrangement is avoided. Because the gear wheels are helical type there is an axial force component when applying torque to the speed gear. If the speed gear was a synchro gear (loose speed gear) there would be an operating condition of being loaded while spinning with reference to the shaft. This then creates higher requirements for the bearings resulting in cost, weight, space increase and further failure mode risks.

By providing a selector in the MGU assembly what can switch between two different torque paths and a neutral position, the operational and ratio flexibility is maximized. The design also allows for 0, 1 or 2 or more gear steps connecting the MGU (M) to the MGU torque transfer shaft (55); this allows an increase in packaging flexibility to place the MGU relative to the transmission and a generation of a higher ratio, allowing a higher-speed/lower-torque motor that is more compact.

The double clutch transmission (10) may be configured for driving in a pure electric mode that is range optimised. In such case, the selector (57) may select the torque path (left in FIG. 4) where torque is transferred via a transmission output shaft (26). This arrangement optimises driving autonomy since the MGU (M) is connected as close to the wheels as possible thereby reducing losses by not going through the speed gears. It is preferred that no speed gear would be selected in the dual clutch transmission i.e. the transmission is in neutral. Reverse gear is selected by reversing the MGU direction of rotation.

The double clutch transmission (10) may be configured for driving in a pure electric mode that is optimised for sports performance. In such case, the selector (57) may select the torque path (right in FIG. 4) where torque is transferred via a transmission input shaft (3, 4). The lowest speed gear pair selected can provide a high acceleration or tyre-grip-surpassing acceleration while a higher gear could still provide a better, sportier acceleration with a higher maximum vehicle speed.

A sporty interrupt shift can be performed to go up to the next gear on the same transmission input shaft (3, 4) and continue the full electric acceleration. During gear change from a lower gear to a higher gear on the same transmission input shaft (3, 4), the selector (synchroniser) of the lower gear may be disengaged, the speed of the MGU synchronised to the new speed by a control unit and the next gear engaged. The MGU may also be brought up to speed by the selector (synchroniser) of the upper gear. This strategy is maybe atypical for electric cars. It brings a sports-car feeling to pure electric drive.

Reverse gear is selected by reversing the MGU direction of rotation.

The double clutch transmission (10) may be configured for driving in a hybrid mode wherein shift feeling is enhanced. Shift feeling may be introduced to add a sporty and fun-to-drive aspect to the car. Shift feeling may be an intentional drop in acceleration during gear changes; this is known as shift interrupt. Shift feeling may be an intentional increase in acceleration during gear changes; this is known as shift boost. It is a desirable feature of manual ICE vehicles cars, and in hybrid mode, that the MGU can be used to enhance both effects by aligning changes of power supplied by the MGU with the gear change.

For shift feeling enhancement, the selector (57) may select the torque path (left in FIG. 4) where torque is transferred via a transmission input shaft (3,4). This is typically the case for hybrid vehicles with smaller ICEs.

With the MGU-connected transmission input shaft (3,4) of the active or the new gear the shift interrupt feel can be enhanced by the MGU by reducing MGU torque at the same time as the clutches provide an interrupted sum torque, thereby momentarily reducing acceleration before the new gear is engaged. In another example, negative torque can be torque supplied by the MGU to the odd numbered gear thereby forcing a greater reduction in acceleration before the new gear is engaged.

With the MGU-connected transmission input shaft (3,4) of the active or the new gear the shift boost feel can be enhanced by the MGU by increasing MGU torque at the same time as the clutch of the new gear provides an increased torque, thereby momentarily increasing acceleration while the new gear is being engaged.

Alternatively for shift feeling enhancement, the selector (57) may select the torque path (right in FIG. 4) where torque is transferred via a transmission output shaft (26, 26a, 26a′, 26b); in this mode, a shift interrupt or shift boost can be applied in any gear.

The shift interrupt feel of the change upwards gear change can be enhanced by the MGU. For instance, torque supplied by the MGU to the transmission output shaft (26, 26a, 26a′, 26b) can be reduced at the same time as the clutches provide an intentionally interrupted sum torque, thereby momentarily reducing acceleration before the next gear is engaged. In another example, negative torque can be supplied by the MGU to the transmission output shaft (26, 26a, 26a′, 26b) thereby forcing a greater reduction acceleration before the next gear is engaged.

The shift boost feel of the change upwards gear change can be enhanced by the MGU. For instance, torque supplied by the MGU to the odd numbered gear can be increased at the same time as the clutch of the new gear provides an intentionally increased torque, thereby momentarily increasing acceleration after the even numbered gear has been engaged.

The double clutch transmission (10) may be configured for driving in a hybrid mode wherein shift feeling is suppressed. Due to the nature of DCT shifts in combination with ICE torque capabilities there are conditions where car acceleration is briefly reduced during a DCT shift. The ICE speed has to be reduced to the speed of the new higher gear before the ICE torque can increase to bring the car acceleration back to the level of before the shift. In these conditions the MGU could be used to “fill the torque hole” in the system.”

For shift feeling suppression, the selector (57) may select the torque path (left in FIG. 4) where torque is transferred via a transmission input shaft (3,4), or the selector select the torque path (right in FIG. 4) where torque is transferred via a transmission output shaft (26, 26a, 26a′, 26b).

The double clutch transmission (10) may be configured to crank the ICE when in standstill. In such case, the selector (57) may select the torque path (left in FIG. 4) where torque is transferred via a transmission input shaft (3,4). The corresponding clutch is closed and the gears on that transmission input shaft (3,4) need to be in neutral to be able to crank the engine without vehicle movement. This state may also be used to charge the battery at standstill.

The double clutch transmission (10) may be configured in a battery charge mode while driving on ICE. In such case, the selector (57) may select the torque path (right in FIG. 4) where torque is transferred via a transmission input shaft (3, 4). The ICE delivers an additional amount of torque that is converted by the MGU to charge the battery. Charging proceeds both while driving using a speed gear of the transmission input shaft (3,4) having the MGU connection, or while driving using a speed gear of the other transmission input shaft (3,4).

The double clutch transmission (10) may be alternatively (less preferred) configured in a battery charge mode while driving on ICE. In such case, the selector (57) may select the torque path (left in FIG. 4) where torque is transferred via a transmission output shaft (26, 26a, 26a′, 26b). The ICE delivers an additional amount of torque that is converted by the MGU to charge the battery.

The double clutch transmission (10) may be configured in a battery charge mode while in standstill. In such case, the selector (57) may select the torque path (right in FIG. 4) where torque is transferred via a transmission input shaft (3, 4). When no speed gear is selected, the ICE delivers an additional amount of torque via transmission input shaft (3, 4) that is converted by the MGU to charge the battery.

The double clutch transmission (10) may be configured to provide a smooth stop-start functionality applied from standstill or during driving at a speed. In such case, the selector (57) may select the torque path (right in FIG. 4) where torque is transferred via transmission input shaft (3, 4); when no speed gear is selected on that transmission shaft the MGU would be able to crank the ICE.

When launching from standstill, preferably the vehicle would launch on the other transmission input shaft (3, 4) (with clutch slip). When launching from standstill while cranking the ICE (12), the clutch (20, 28, 30) on the other transmission input shaft (3, 4) is used to smoothly transfer torque from the ICE (12) to the main output shaft (26b) via the speed gears pairs attached the other transmission input shaft (3, 4). Accordingly, the ability is there to crank the ICE and simultaneously start launching the vehicle, this would result in a smooth launch without crank disturbance on the driveline.

When driving at speed, and the accelerator pedal is released the ICE may be disconnected and shut down (to save fuel). To start the ICE again and have ICE acceleration available, the smoothest and fastest way would be to crank and bring the ICE up to speed by the MGU via one of the transmission input shafts (3, 4), and preparing the other clutch and other transmission input shaft (3, 4) with the correct engaged gear to bring torque to the wheels.

Hence, when driving at speed and a release of accelerator pedal causes the ICE (12) to shut down (to save fuel), the ICE (12) may be recranked by selecting with the selector (57) the torque path where torque is transferred via one of the transmission input shafts (3) from the MGU (M) to the ICE (12) to be able to crank the ICE (12) while the corresponding clutch (20, 28, 30) is closed; the clutch (20, 28, 30) on the other transmission input shaft (4) is used to smoothly transfer torque from the ICE (12) to the main output shaft (26b) via the speed gears pairs attached the other transmission input shaft (4).

The double clutch transmission (10) may be configured for driving in a hybrid mode that is a smart mode, where highway/motorway driving is used to charge the battery, and when reaching a city or town from the highway/motorway pure electric mode is used on the recharged battery.

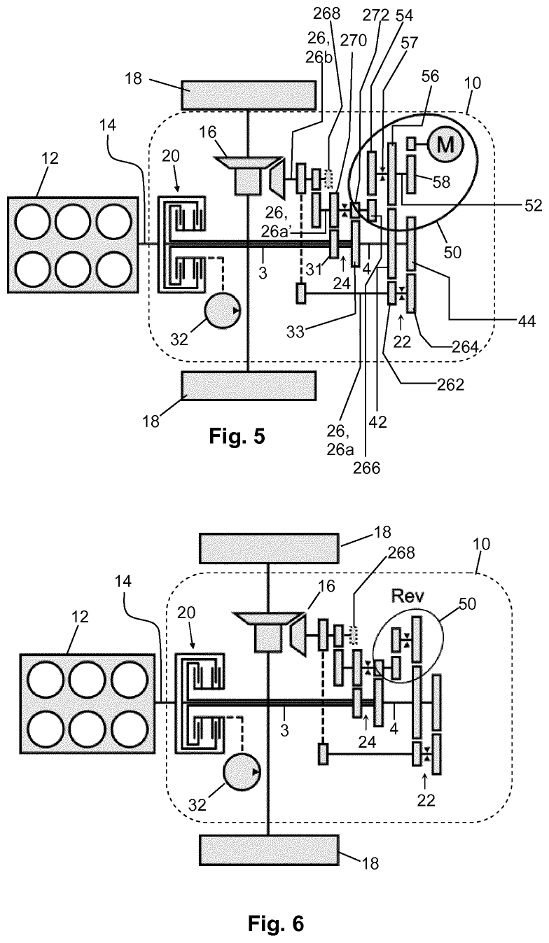

An example is shown in FIG. 5 showing a double clutch transmission (10) having the same core configuration as FIG. 4 and similar components to the double clutch transmission (10) of FIG. 1 with the inclusion of the selectively connectable MGU (M). The connection is repeatable i.e. can be connected and disconnected by actuation. The MGU (M) is connected by its torque transfer shaft (52) that provides torque (shaft as output) or can receive torque for electricity generation (shaft as input). The MGU (M) may be connected via one or more additional gear steps between the MGU (M) and gear (58), which are not shown. In FIG. 5, the MGU (M) is selectively connectable via gear (56) to the transmission input shaft (4), or via gear (54) to the transmission output shaft (26, 26a′). The selector (57) is indicated, which also has a neutral position. The connection may be described as drivable or operatively connectable. The MGU assembly (50) comprises the MGU (M). The MGU assembly (50) may be configured to selectively connect by actuation the MGU (M) to one of the transmission input shaft (3,4) or to a transmission output shaft (26), or selectively disconnect by actuation the MGU (M) from the one of the transmission input shaft (3,4) or the transmission output (26). In FIG. 4, the MGU assembly further comprises gears (54, 56, 58). One or more additional gear steps between the MGU (M) and gear (58) may be present in the MGU assembly (50), which are not shown.

In FIG. 6 is a double clutch transmission (10) having similar components to the double clutch transmission (10) of FIG. 5; reverse gear being achieved by reversing the direction of turning of the output of the MGU, does not require additional mechanical parts.

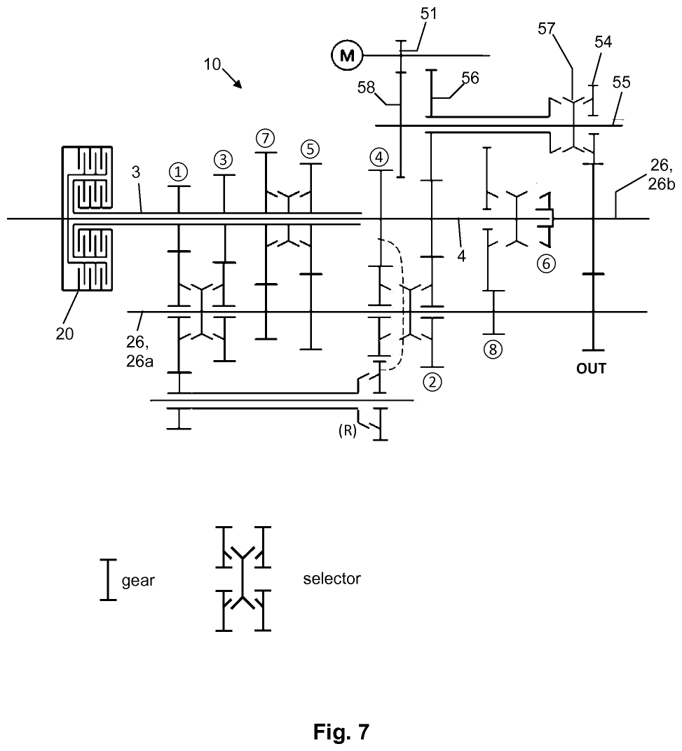

In FIG. 7 is a double clutch transmission (10) (8 speed gears) showing a double clutch transmission (10) having the same core configuration as FIG. 4. Dual clutch transmits torque from the ICE (not shown) to an outer transmission input shaft (3) or an inner transmission input shaft (4). Odd speed gears 1, 3, 5, 7 are mounted in fixed (permanent) rotational relation to the outer transmission input shaft (3). Even speed gears 2, 4, 8 are mounted in fixed (permanent) rotational relation to the inner transmission input shaft (4). “Gear” 6 is a direct connection to the main output shaft (26b). The other speed gear pairs are mounted on a transmission output shaft (26) that is a countershaft (26a). Output (OUT) from the counter shafts (26a, 26a) is sent to a transmission output shaft (26) that is a main output shaft (26b). Reverse gear (R) (optional) is meshed with the 1st gear wheel mounted on the inner transmission input shaft (4). MGU (M). The MGU (M) is connected (i.e. drives or is driven by) an MGU torque transfer shaft (55) via gears (51, 58). Torque transfer shaft (55) is provided with two loose gear wheels (54, 56), wherein none or either one of the two loose gear wheels (54, 56) can be brought into fixed rotation with the torque transfer shaft (55) by the selector (57). When loose gear wheel (56) is selected, the torque path is through the inner transmission input shaft (4). When loose gear wheel (54) is selected, the torque path is through the transmission output shaft (26) that is the countershaft (26a).

In FIG. 8 is a double clutch transmission (10) (8 speed gears) showing a double clutch transmission (10) having the same core configuration as FIG. 4. Dual clutch transmits torque from the ICE (12) to an outer transmission input shaft (3) or an inner transmission input shaft (4). Odd speed gears 1, 3, 5, 7 are mounted in fixed (permanent) rotational relation to the inner transmission input shaft (4). Even speed gears 2, 4, 6, 8 are mounted in fixed (permanent) rotational relation to the outer transmission input shaft (3). The other speed gear pairs are mounted on two transmission output shafts (26) that are a 1^{st} countershaft (26a) and a 2^{nd} countershaft (26a′). Output (OUT) from the 1^{st} and 2^{nd} counter shafts (26a, 26a′) is sent to a transmission output shaft (26) that is a main output shaft (26b) which transmits torque to a differential (16) driving the wheels. The MGU (M) is connected (i.e. drives or is driven by) an MGU torque transfer shaft (55) via 2 gear steps comprising gears (51, 51′, 58). Torque transfer shaft (55) is provided with two loose gear wheels (54, 56), wherein none or either one of the two loose gear wheels (54, 56) can be brought into fixed rotation with the torque transfer shaft (55) by the selector (57). When loose gear wheel (56) is selected, the torque path is through the inner transmission input shaft (4). When loose gear wheel (54) is selected, the torque path is through the 2^{nd} transmission output shaft (26) that is the countershaft (26a′).

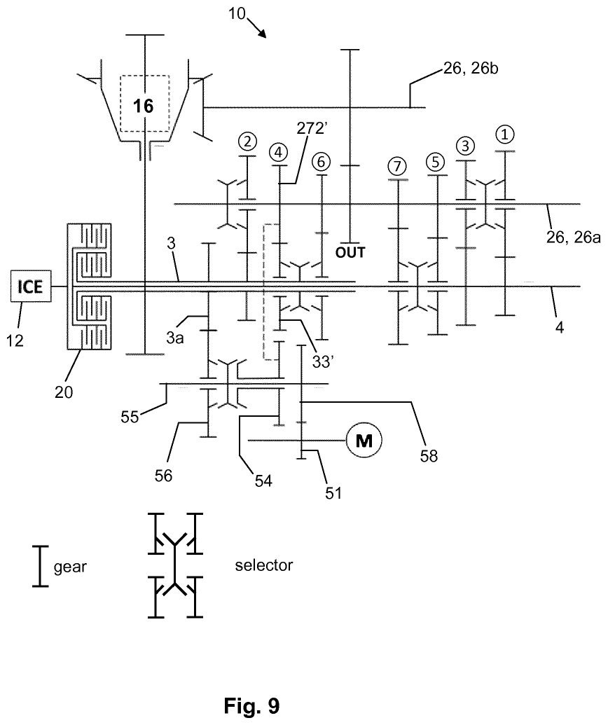

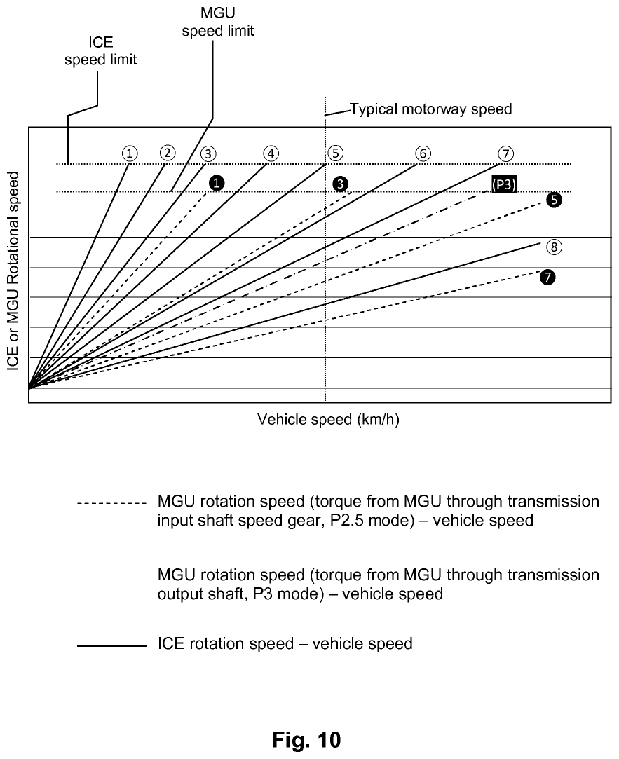

FIG. 9 is a double clutch transmission (10) (7 speed gears) showing a double clutch transmission (10) having the same core configuration as FIG. 4. Dual clutch transmits torque from the ICE (12) to an outer transmission input shaft (3) or an inner transmission input shaft (4). Odd speed gears 1, 3, 5, 7 are mounted in fixed (permanent) rotational relation to the inner transmission input shaft (4). Even speed gears 2, 4, 6 are mounted in fixed (permanent) rotational relation to the outer transmission input shaft (3). The other speed gear pairs are mounted on two transmission output shafts (26) that are a countershaft (26a). Output (OUT) from the counter shaft (26a) is sent to a transmission output shaft (26) that is a main output shaft (26b) which transmits torque to a differential (16) driving the wheels. The MGU (M) is connected (i.e. drives or is driven by) an MGU torque transfer shaft (55) via 1 gear step comprising gears (51, 58). Torque transfer shaft (55) is provided with two loose gear wheels (54, 56), wherein none or either one of the two loose gear wheels (54, 56) can be brought into fixed rotation with the torque transfer shaft (55) by the selector (57). When loose gear wheel (56) is selected, the torque path is through the inner transmission input shaft (3) via a non-speed gear wheel (3a). When loose gear wheel (54) is selected, the torque path is through the transmission output shaft (26) that is the countershaft (26a) via a speed gear wheel (272′) that is 4^{th} gear.

FIG. 10 shows an exemplary ICE (12) and MGU (M) speed curves using speed gear ratios as indicated in Tables 1 and 2. Gear speeds are indicted in white circles when ICE (12) driven, and in black circles or black box when MGU (M) driven. Speed gear ratios are chosen in such way that typical motorway driving speed is supported in pure electric driving mode (P2.5 mode) in 3^{rd} gear. Larger speed gear ratios are available in P2.5 mode than in P3 mode, result in higher acceleration in pure electric mode.

If vehicle top speed would surpass MGU maximum speed in P3 mode, then shifting into P2.5 mode with a high gear (e.g. 5th or 7th gear) selected is possible to enable electric power boost to vehicle speed. In this case, the ICE selected or preselected gear is also likely to be one of the highest gears, enabling the P2.5 mode selection for the MGU.

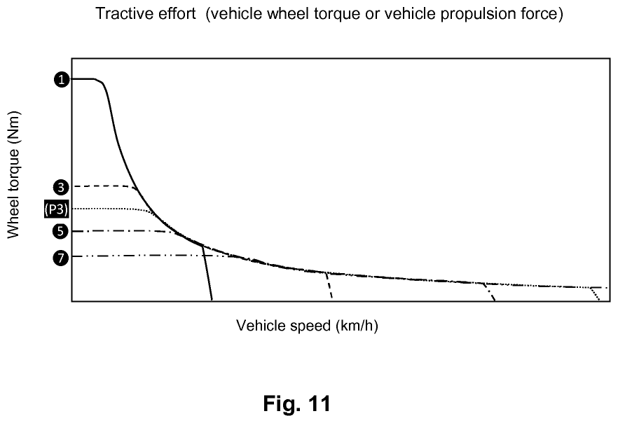

FIG. 11 shows an exemplary MGU (M) tractive effort depending on the selected gear using speed gear ratios as indicated in Tables 1 and 2. Gear speeds are indicted in black circles or a black box when MGU (M) driven. The arrangement provides a wide range of selectable tractive efforts.

The decision to which one of the two transmission input shaft (3, 4) the MGU (M) may be connected is a design choice and may not be selectable during operation. This decision may be based on performance simulations but may be limited due to design and packaging constraints. The selective connection may be effected with a dog clutch or other connection device with or without a mechanical synchronization.

When the MGU (M) is connected to the transmission output shaft (26) the MGU has optimal boosting capabilities in the most efficient setup since only the torque from the combustion engine passes through the entire gearbox. The torque produced by the MGU is directly added to the transmission output (26). This the most direct and efficient way of boosting and avoids the need to dimension the gearbox for the sum of both the combustion and the electric torque level or alternatively avoids the need to limit the combined torques to what the gearbox can handle. Also for regeneration this setup is the most efficient since it uses the shortest, most direct connection to the transmission output.

When the MGU (M) is connected to the transmission input shaft (3, 4) there is the ability to crank a connected combustion engine as well as charge the battery while standing still. This setup also allows the MGU (M) to be used for boosting or pure electric drive. For pure electric drive the gears of the corresponding clutch can be used to have different torque and speed multiplications. Where the MGU connection to the output typically spans a large portion of the maximum vehicle speed, this setup in combination with a selected lower gear can be used to allow higher acceleration levels in pure electric drive up to a limited vehicle speed. When the MGU is connected to the transmission input shaft (3, 4) it can be used to boost in the gear that is currently transmitting the combustion torque, although with respect to torque limits, as well as to boost while the combustion engine is transmitting torque through a gear of the other clutch of the double clutch gearbox.

Both the MGU (M) connection to the transmission input shaft (3, 4) and the MGU connection to the transmission output (26) can work without the need or the losses coming from a main hydraulic pump which is typically combustion engine driven. The invention only needs hydraulic power to select gears and eventually disengaging the park system. Gear lubrication during electric drive could be managed by splash or by a dedicated gear lubrication pump, avoiding the need and the losses from a main pump that needs to run continuously. Both setups can also provide an electric reverse by turning the MGU in the opposite direction, this avoids the need for the gears and the actuators to accomplish a mechanical reversing.

Based on for example the hybrid mode selected by the driver, the vehicle speed, state of charge of battery, request for reverse and other inputs or algorithms the transmission control unit (34) can decide if and how to connect the MGU (M) to the drivetrain. Several examples of choices for a specific MGU (M) connection can be given.

For pure electric city drive the MGU (M) could be connected to the transmission input shaft (3, 4) together with a lower selected gear in the transmission, this results in a high electric propulsion force but with limited vehicle speed. For a spirited hybrid drive the MGU could be connected to a transmission output shaft to be able to provide the maximum boost capabilities. To charge the battery while driving or load point shifting the MGU could be connected to the transmission input shaft (3, 4) even while driving in a gear on the other clutch to have the shortest and most efficient way of driving the MGU. While for a long distance constant speed highway drive the MGU could be disconnected to minimize spin losses.

The transmission may be provided in both hybrid and non-hybrid form, sometimes referred to as modularity. A non-hybrid transmission still needs a mechanical reversing gear. The present double clutch transmission allows the actuation system of the selectable MGU connection to be re-used to actuate reverse gear on a non-hybrid transmission. The invention allows a non-mechanical reverse hybrid transmission to be converted with minimal changes into a conventional transmission with mechanical reverse gear. The gears, shafts, hydraulic actuation systems all stay the same, only the MGU (M) with its selection gears are replaced with a reverse gear (see FIG. 6).

The dual clutch transmission (10) may be configured for coupling with the ICE (12) mounted in a longitudinal or transverse direction of a vehicle. The dual clutch transmission may be configured for coupling inline with the ICE (12). Also provided is a use of the dual clutch transmission in a vehicle wherein the combustion engine is longitudinal or transverse mounted direction of a vehicle. Further provided is a vehicle comprising the dual clutch transmission.

1. A dual clutch transmission for a vehicle, comprising:
two sets of selectable speed gear pairs,
one or more transmission output shafts, at least one transmission output shaft being a countershaft,
an outer transmission input shaft and an inner transmission input shaft configured to be connected to an internal combustion engine, ICE, via a dual clutch
two sets of speed gears each set comprising a plurality of speed gear pairs,
wherein
in one set of speed gears, one gear of each speed gear pair is attached to the outer transmission input shaft, and
in the other set of speed gears, one gear of each speed gear pair is attached to the inner transmission input shaft,
the other gear of each speed gear pair being attached to the at least one countershaft, wherein torque is transferred between the outer or inner transmission input shaft and the at least one countershaft via a selected speed gear pair,
a motor generator unit, MGU (M), connected via 0, 1 or more gear steps, to an MU torque transfer shaft, wherein:
the torque transfer shaft on which two loose gear wheels are rotationally mounted, wherein none or either one of the two loose gear wheels can be brought into fixed rotation with the torque transfer shaft by a selector;
one of the loose gear wheels on the torque transfer shaft is meshed via 0, 1 or more gear steps with a fixed gear wheel on one of the transmission output shafts, and
the other loose gear wheel on the torque transfer shaft is meshed via 0, 1 or more gear steps with a fixed gear on one of the transmission input shafts
the fixed gear wheel on one of the transmission input shaft and/or the fixed gear wheel on one of the transmission output shafts that meshes via the 0, 1 or more gear steps with the loose gear wheel on the torque transfer shaft is a gear of a speed gear pair.

2. The dual clutch transmission according to claim 1, configured for selectively operating in a pure electric driving mode in which the selector selects a torque path in which torque is transferred from the motor generator unit, MGU (M) via one of the transmission output shafts.

3. The dual clutch transmission according to claim 1, configured for selectively operating in a sports performance pure electric driving mode in which the selector selects a torque path where torque is transferred from the motor generator unit, MGU (M) via one of the transmission input shafts, and gears shifts use the set of speed gears pairs attached to the same one transmission input shaft.

4. The dual clutch transmission according to claim 1, configured for selectively operating in a battery charge mode while driving on the ICE, wherein the selector selects the torque path where torque is transferred via one of the transmission input shaft, and the ICE delivers an additional amount of torque that is converted by the MGU into power to charge the battery.

5. The dual clutch transmission according to claim 1, configured for selectively operating in a hybrid mode that is a shift feeling enhancement mode wherein torque supplied by the MGU (M) causes an enhanced shift interrupt feel of a speed gear change by reducing or supplying negative torque during a shift, thereby enhancing a drop in acceleration during a speed gear change.

6. The dual clutch transmission according to claim 1, configured for selectively operating in a hybrid mode that is a shift feeling enhancement mode wherein the torque supplied by the MGU causes an enhanced shift boost feel of a gear change by increasing torque during and after clutch closing, thereby enhancing an increase in acceleration after a new speed gear change.

7. The dual clutch transmission according to claim 1, configured for selectively operating in a smooth stop-start mode applied from standstill or during driving at a speed, wherein:
when launching from standstill the selector selects the torque path where torque is transferred via one of the transmission input shafts from the MGU (M) to the ICE to be able to crank the ICE while the corresponding clutch is closed with no speed gear selected; and
the clutch of the other transmission input shaft, is used to smoothly transfer torque from the ICE to the main output shaft via the speed gears pairs attached to the other transmission input shaft
and
when driving at speed and a release of accelerator pedal causes the ICE to shut down, the ICE is recranked by selecting with the selector the torque path where torque is transferred via one of the transmission input shafts from the MGU (M) to the ICE to be able to crank the ICE while the corresponding clutch is closed with no speed gear selected; and the clutch of the other transmission input shaft, is used to smoothly transfer torque from the ICE to the main output shaft via the speed gears pairs attached the other transmission input shaft.

8. The double clutch transmission according to claim 1, configured for driving in a hybrid mode wherein shift feeling is suppressed, wherein the selector selects the torque path where torque is transferred via a transmission input shaft, or the selector selects the torque path where torque is transferred via a transmission output shaft, and the MGU is applied to compensate at times where vehicle acceleration is briefly reduced due to the nature of DCT shifts in combination ICE capabilities.

9. The dual clutch transmission according to claim 1, further comprising a control unit configured to determine based on one or more inputs including one or more of vehicle speed, hybrid mode, battery state of charge, driving direction, the position of the selector and a control of the MGU (M) torque output.

10. The dual clutch transmission according to claim 1, wherein the fixed gear of the speed gear pair on one of the transmission input shafts and/or on one of the transmission output shafts to which the loose gear loose gear wheels on the torque transfer shaft is meshed with is an odd numbered speed gear.

11. The dual clutch transmission according to claim 10, wherein the odd numbered speed gear meshed is a 3^{rd} speed gear.

12. The dual clutch transmission according to claim 1, wherein the fixed gear of the speed gear pair to which the loose gear loose gear wheels on the torque transfer shaft is meshed via 0, 1 or more gear steps is only on the transmission input shafts.

13. The dual clutch transmission according to claim 1 that is a transaxle.

14. The dual clutch transmission according to claim 1, comprising a differential positioned behind or in front of the speed gears in a direction of travel, optionally in a transaxle.

15. The dual clutch transmission according to claim 1 configured for coupling with an internal combustion engine mounted in a longitudinal or transverse direction of a vehicle, optionally inline with the internal combustion engine.
